(19) United States
(12) Patent Application Publication
(10) Pub. No.: US 2024/0350351 A1
(43) Pub. Date: Oct. 24, 2024

(54) PRESSURE ULCER BOOT

(71) Applicant: The University of Toledo, Toledo, OH (US)

(72) Inventors: Munier Nazzal, Toledo, OH (US); Abdullah Nasif, Toledo, OH (US); Karen Bauer, Toledo, OH (US); Mohamed Osman, Toledo, OH (US); Josh N. Moskall, Toledo, OH (US); Raelyn E. Nyren, Toledo, OH (US); Mathieu K. Holt, Toledo, OH (US); Logan K. Simmons, Toledo, OH (US)

(73) Assignee: The University of Toledo, Toledo, OH (US)

(21) Appl. No.: 18/640,844

(22) Filed: Apr. 19, 2024

Related U.S. Application Data
(60) Provisional application No. 63/460,929, filed on Apr. 21, 2023.

(51) Int. Cl. A61H 9/00

(52) U.S. Cl. CPC A61H 9/0092; A61H 2201/0103; A61H 2201/1238; A61H 2201/1642; A61H 2201/5007; A61H 2203/0443; A61H 2205/106

(57) ABSTRACT

A pressure ulcer boot includes a boot body formed from a layer of flexible material, an array of selectively inflatable and deflatable air pockets mounted to a portion of the boot body, an air pump in fluid communication with the array of air pockets, and a micro-processor operative to control the air pump to selectively inflate and deflate the air pockets and to apply pressure via the air pockets at regular intervals to increase circulation and relieve pressure in a portion of a patient's body with which the pressure ulcer boot is in contact.

### BACKGROUND OF THE INVENTION

This disclosure relates in general to lower extremity protection devices. In particular, this disclosure relates to an improved pressure ulcer boot that offloads weight and reduces the occurrence of pressure ulcers.

Pressure ulcer boots are commonly recommended for bed-confined patients who are experiencing, or subject to, pressure ulcer formation. Pressure ulcers are unfortunately common and form on the skin after prolonged pressure on certain parts of the body such as the heel, back, shoulder, and sacrum. Pressure ulcers are sometimes referred to as bedsores. The prolonged pressure applied to a point causes loss of circulation to that pressure point on the body. To prevent pressure ulcer formation, those pressure points should be altered continuously. Currently, this is achieved by changing the position of the patient by a medical professional, such as a nurse, or other caregivers, which is not efficient and requires timely attention to the patient. The heel is one of the body areas that is frequently and negatively affected by a pressure ulcer.

Pressure ulcers are a common problem in all healthcare facilities. The best treatment for them is prevention. There are many devices in the market that try to minimize pressure ulcers. However, these known devices typically only shift pressure from one area of the body to another area of the body, such as from the heel to the distal leg, and pressure injury may still occur.

It is estimated that pressure ulcers and/or injuries affect up to 23 percent of patients in long-term and rehabilitation facilities, and between 10 and 41 percent of ICU patients. Additionally, about 2.5 million individuals may be affected by pressure ulcers, and more than 60,000 patients in the United States die each year as a direct result of pressure ulcers. The cost of treating pressure ulcers is high. For example, in the United States, the cost of treating pressure ulcers is between US $9.1 and US $11.6 billion per year, and the treatment cost of each case is between US $20,000 and US $150,000. Further, more than 17,000 lawsuits annually are related to pressure ulcers, making lawsuits relating to pressure ulcer claims the second most common claim after wrongful death claims.

A study performed from 2008 to 2012 evaluated the details of pressure ulcers in the United States in 1000 community hospitals in 47 states. The study determined that the mean age of a patient with a pressure ulcer was 71.2 years+/−16.8 years, and concluded that pressure ulcer formation occurs in patients more frequently when patients are older, malnourished, and immobile.

As the general population continues to age and life expectancy increases, the incidence of pressure ulcers also increases. Therefore, preventative care for pressure ulcers is becoming significantly more important. Learning how to prevent pressure ulcers has also become increasingly important due to the increased number of therapies available that do not demonstrate any clear benefit for pressure ulcer treatment, such as offloading the pressure source, draining the infection areas, and administering wound care to aid the healing process.

The occurrence of pressure ulcers has been increasing in hospitalized patients, nursing homes, and ICUs. This increased occurrence of pressure ulcers has required increased resources, both directly and indirectly, to be spent on pressure ulcers.

Additionally, biophysical treatments, similar to direct electric stimulation and biologic dressings, are used to aid the healing process for pressure ulcers. If the pressure ulcer is too severe and large, then surgery may be the only procedure available. Improving the prevention of pressure ulcers remains a key step in the management of these wounds.

Thus, it would be desirable to provide an improved structure for a pressure ulcer device that offloads weight to prevent pressure ulcer formation caused by prolonged immobility.

### SUMMARY OF THE INVENTION

This disclosure relates to an improved structure for a pressure ulcer boot that offloads weight to prevent pressure ulcer formation caused by prolonged immobility. In one embodiment, the pressure ulcer boot includes a boot body formed from a layer of flexible material, an array of selectively inflatable and deflatable air pockets mounted to a portion of the boot body, an air pump in fluid communication with the array of air pockets, and a micro-processor operative to control the air pump to selectively inflate and deflate the air pockets and to apply pressure via the air pockets at regular intervals to increase circulation and relieve pressure in a portion of a patient's body with which the pressure ulcer boot is in contact.

In another embodiment, a method of increasing circulation in the lower extremities of a bed-ridden patient includes placing a flexible pressure ulcer boot in contact with a portion of a lower extremity of a bed-ridden patient for whom increased circulation is desired. The pressure ulcer boot includes a boot body formed from a layer of flexible material, an array of selectively inflatable and deflatable air pockets mounted to a portion of the boot body, an air pump in fluid communication with the array of air pockets, and a micro-processor operative to control the air pump. The array of air pockets is positioned on the posterior side of the portion of the lower extremity. The air pockets in the array of air pockets are selectively inflated and deflated, thus relieving pressure on the posterior side of the patient's lower extremity and keeping the blood in the patient's lower extremity moving.

In an additional embodiment, a pressure ulcer boot includes a boot body formed from two layers of flexible foam material, an array of selectively inflatable and deflatable air pockets mounted between the two layers of flexible foam material, an air pump in fluid communication with the array of air pockets, and a micro-processor operative to control the air pump to selectively inflate and deflate the air pockets and to apply pressure via the air pockets at regular intervals to increase circulation and relieve pressure in a portion of a patient's body with which the pressure ulcer boot is in contact. The boot body is configured to wrap around the portion of the patient's body such that the array of air pockets is positioned on the posterior side of the portion of the patient's body, and the pressure ulcer boot is secured to the portion of the patient's body with at least one fastening strap.

Various aspects of the present disclosure will become apparent to those skilled in the art from the following detailed description when read in view of the accompanying drawings.

### BRIEF DESCRIPTION OF THE DRAWINGS

FIG. 1 is a front elevational view of a first embodiment of pressure ulcer boot in accordance with this disclosure and shown in a closed position on a human leg.

FIG. 2 is a rear elevational view of the pressure ulcer boot illustrated in FIG. 1 and shown in an open position.

FIG. 3 is a perspective view of an outside surface of a second embodiment of the pressure ulcer boot shown in the open position.

FIG. 4 is an enlarged view of a portion of the air pockets of the pressure ulcer boots illustrated in FIGS. 1 through 3.

FIG. 5 is a side elevational view of the air pockets of the pressure ulcer boot illustrated in FIG. 4.

FIG. 6 is a schematic illustration of the operational components of the pressure ulcer boots illustrated in FIGS. 1 through 3.

FIG. 7 is a plan view of a third embodiment of pressure ulcer boot in accordance with this disclosure and shown in an open position.

FIG. 8 is a side elevational view of the pressure ulcer boot illustrated in FIG. 7 and shown in a closed position on a human foot and ankle.

### DETAILED DESCRIPTION

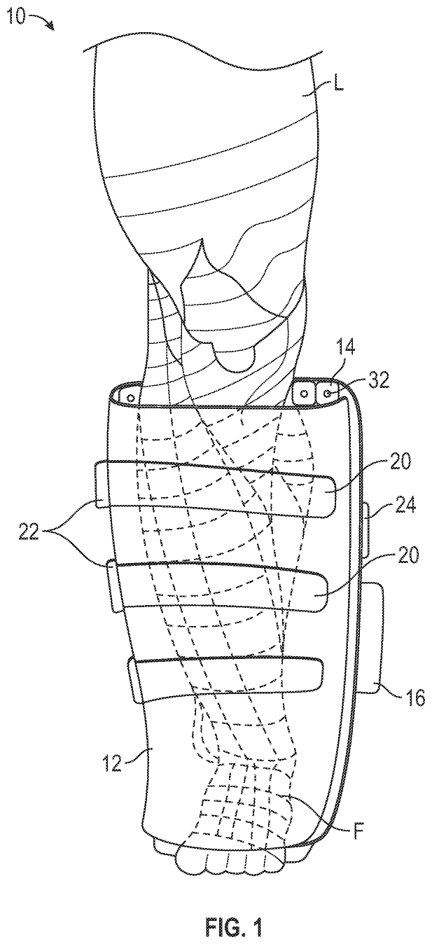

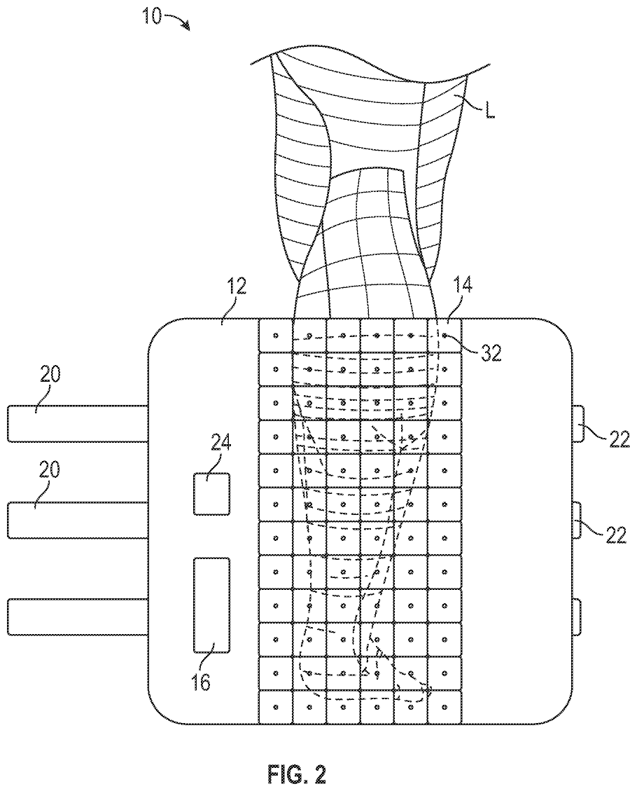

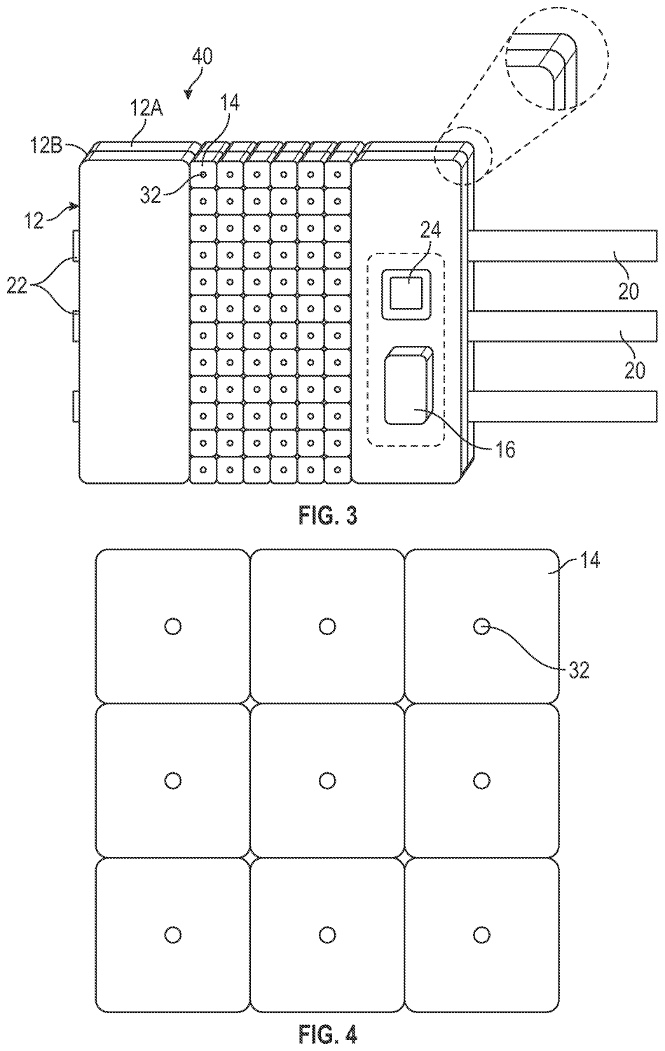

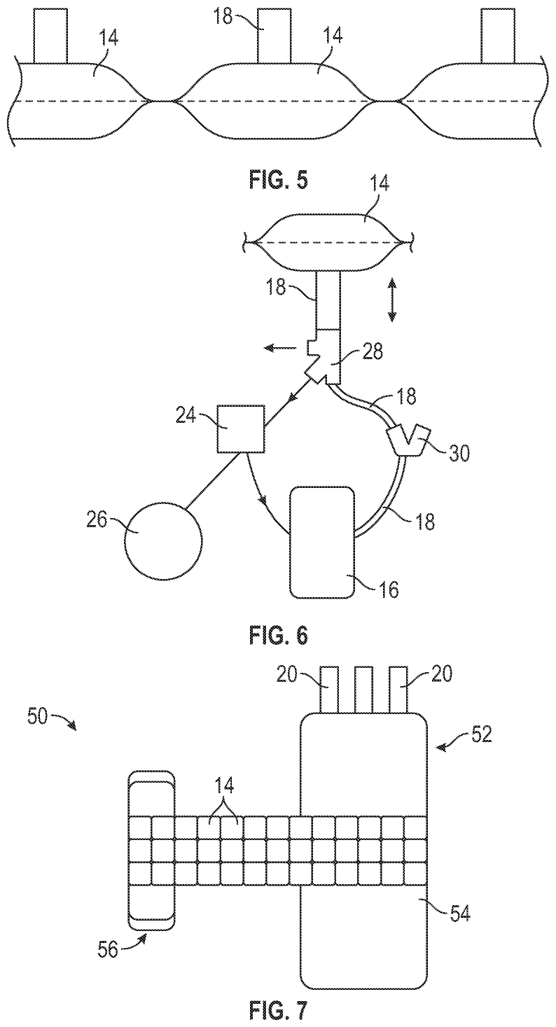

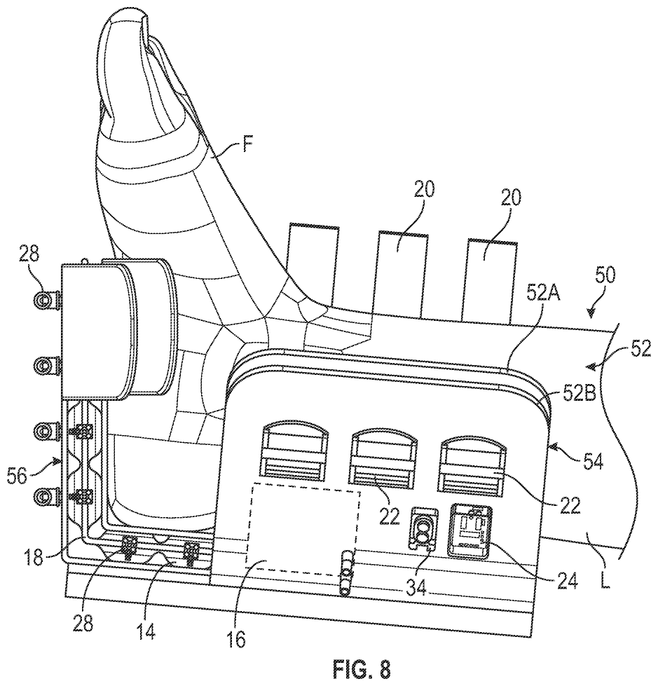

Referring now to the drawings, there is illustrated in FIGS. 1 and 2 a basic structure of a pressure ulcer boot, shown generally at 10. The illustrated pressure ulcer boot 10 includes a boot body 12. The boot body 12 may be formed from a layer flexible material, such as foam or fabric, and has an array of selectively inflatable and deflatable air pockets 14 in fluid communication with an air pump 16 via air-flow tubes 18 (see FIGS. 6 and 8). In the embodiment illustrated in FIGS. 1 and 2, the boot body 12 is formed from a single layer of material. Alternatively, the boot body 12 may be formed from two layers of material, such as shown at 12A and 12B in an alternate embodiment of the pressure ulcer boot 40 illustrated in FIG. 3, and as shown at 52A and 52B in FIG. 8, described below.

The boot body 12 also includes a plurality of fastening straps 20 and a plurality of corresponding buckles 22. In the embodiments illustrated, there are three straps 20 and three buckles 22 shown. It will be understood however, that the each of the illustrated boot bodies 12 may have more than three or fewer than three straps 20 and corresponding buckles 22. Alternatively, instead of the illustrated straps 20 and buckles 22, the boot bodies 12 may be provided with one or more pairs of hook-and-loop fastening straps (not shown).

The boot body 12 also includes a computer chip or micro-processor 24 configured to control the operation of the air pump 16. The microprocessor 24 may be powered by a source of power, such as a battery within the boot body 12, as shown a 26 in FIG. 6. If desired, one or more air-flow valves 28 may be attached within one or more of the air-flow tubes 18 and electrically connected to the microprocessor 24. An air-flow distributor 30, described below, may also be attached within one or more of the air-flow tubes 18 to channel the flow of air to a plurality of air-flow tubes 18 and/or a plurality of air pockets 14.

The air pockets 14 are configured to be selectively inflated and deflated, and include an aperture 32 for the flow of air into and out of the air pocket 14. A section of the air-flow tube 18 is mounted within the aperture 32.

An air flow control switch, as shown at 34 in FIG. 8, may be provided in the boot body 12 to control the flow of air to and from the air pockets 14 via the air pump 16.

As shown in FIG. 6, the air pump 16 is a single output air pump that utilizes the distributor 30 to pump air to and from the air pockets 14 as required. Alternatively, the pressure ulcer boot 10 may be provided with a multi-channel air pump. In such an embodiment, the distributor 30 may not be required.

As shown in FIGS. 1 and 2, the pressure ulcer boot 10 is configured to be wrapped around and attached to a patient's lower leg L, such that the array of air pockets 14 is in contact with the patient's lower leg L.

A third embodiment of the pressure ulcer boot 50 is shown in FIGS. 7 and 8. As shown, the pressure ulcer boot 50 includes a boot body 52 having a first portion 54 configured for contact with the patient's lower leg L, and a second portion 56 configured for contact with the bottom of the patient's foot F. The boot body 52 is formed from two layers of material 52A and 52B, between which the array of air pockets 14 is mounted. As described above, the layers of material 52A and 52B may be formed from flexible material, such as foam or fabric.

Operation of the illustrated pressure ulcer boots 10, 40, 50 provide continuous shifting of pressure from one area to another, thus allowing blood flow and perfusion to each area of the body in contact with the array of air pockets 14 of the pressure ulcer boots 10, 40, 50.

Advantageously, the embodiments of the pressure ulcer boots 10, 40, 50 described herein are dynamic-based devices capable of applying alternating pressure to multiple locations, including the heel and the back of the calf.

Operation of the pressure ulcer boots 10, 40, 50 may be automated, such as with the micro-processor 24, and will apply pressure at regular intervals to increase circulation and relieve pressure in lower extremity areas that frequently experience, or are otherwise susceptible to, ulcer formation. The pressure ulcer boots 10, 40, 50 are a non-invasive, easy-to-use, automated devices equipped with a pressure changing system. The pressure ulcer boots 10, 40, 50 are configured to change the pressure points on all segments covered by the device without shifting pressure points from one area to another.

The pressure ulcer boots 10, 40, 50 are designed and configured to be placed in contact with high pressure point areas on a patient's lower extremities, such as the posterior of the heel. Once placed in contact with a patient, the pressure boots 10, 40, 50 continuously change the pressure applied to patient's lower extremity in multiple locations to offload each portion of the body, for example the calf, the heel, and the bottom of the foot F, and allow reperfusion of those portions, thus decreasing occurrence of pressure injury.

To maintain its dynamic pressure changing abilities, each of the illustrated pressure ulcer boots 10, 40, 50 includes a plurality of the air pockets 14 in a middle third of the boot body 12, 52. When in use, the array of air pockets 14 will be selectively inflated and deflated, and will thus be adjusted in pressure through the use of the air pump 16. Inflation and deflation occur in sequence.

Advantageously, changing the air pressure of the array of air pockets 14 acts to relieve pressure on the posterior side of the patient's lower extremities, for example, the calf, the heel, and the bottom of the foot F, thus keeping the blood in the patient's leg or legs moving.

The pressure ulcer boots 10, 40, 50 use the air pockets 14 to reduce stagnant pressure and increase circulation in the lower extremities of bed-ridden patients. Referring to FIG. 8, the array of air pockets 14 mounted between the two foam layers 52A and 52B of the boot body 52 will inflate and deflate at predetermined intervals controlled by the micro-processor 24. Multiple rates, intervals, and patterns of inflation and deflation may be applied depending on the patient's needs. Air will be provided from the air pump 16 to the air pockets 14 via a system of air-flow tube 18 and air-flow valves 28. The pressure ulcer boot 50 will remain securely attached to the patient with the plurality of straps 20 and associated buckles 22.

Additionally, the pressure ulcer boots 10, 40, 50 described herein improve upon known devices because they may be used exclusively on a patient's lower extremities, they provide programmable inflating and deflating air pockets 14, and they may be worn rather than only laid upon.

Most significantly, the improved pressure ulcer boots 10, 40, 50 described herein advantageously offload weight to prevent pressure ulcer formation caused by prolonged immobility.

Although the pressure ulcer boots 10, 40, 50 are designed and configured to be used on the lower extremities of the patient, it should be understood that the pressure ulcer boots 10, 40, 50 may also be used on any desired portion of the body, including but not limited to the upper leg, the buttocks, and the back. If desired, a patient my lay upon an embodiment of the pressure ulcer boots 10, 40, 50 in an open position, such as for example as shown in FIG. 7, so as to allow the array of air pockets 14 to contact any desired portion of the patient's body.

The principle and mode of operation of this disclosure have been explained and illustrated in its preferred embodiment. However, it must be understood that this disclosure may be practiced otherwise than as specifically explained and illustrated without departing from its spirit or scope.

What is claimed is:

1. A pressure ulcer boot comprising:
a boot body formed from a layer of flexible material;
an array of selectively and sequentially inflatable and deflatable air pockets mounted to a portion of the boot body;
an air pump in fluid communication with the array of air pockets; and
a micro-processor operative to control the air pump to selectively inflate and deflate the air pockets and to apply pressure via the air pockets at regular intervals to increase circulation and relieve pressure in a portion of a patient's body with which the pressure ulcer boot is in contact.

2. The pressure ulcer boot according to claim 1, wherein the portion of the patient's body with which the pressure ulcer boot is in contact includes an extremity area susceptible to ulcer formation.

3. The pressure ulcer boot according to claim 1, further including a plurality of straps and buckles.

4. The pressure ulcer boot according to claim 3, wherein the boot body is configured to wrap around and be placed in contact with a portion of a lower extremity of a bed-ridden patient for whom increased circulation is desired, and wherein the pressure ulcer boot is configured to be secured to the lower extremity with the plurality of straps and buckles.

5. The pressure ulcer boot according to claim 1, further including a plurality of air-flow tubes fluidly connecting the air pump to the array of air pockets.

6. The pressure ulcer boot according to claim 5, further including one or more air-flow valves attached within one or more of the plurality of air-flow tubes.

7. The pressure ulcer boot according to claim 1, further including a source of power electrically connected to the micro-processor and to the air pump.

8. The pressure ulcer boot according to claim 6, further including a source of power electrically connected to the micro-processor, the air pump, and to the one or more air-flow valves.

9. The pressure ulcer boot according to claim 1, further including an air-flow control switch operative to control the flow of air to and from the air pockets via the air pump.

10. The pressure ulcer boot according to claim 1, wherein the boot body is formed from two layers of material between which the array of air pockets is mounted.

11. A method of increasing circulation in the lower extremities of a bed-ridden patient, the method comprising:
placing a flexible pressure ulcer boot in contact with a portion of a lower extremity of a bed-ridden patient for whom increased circulation is desired, the pressure ulcer boot including:
a boot body formed from a layer of flexible material;
an array of selectively inflatable and deflatable air pockets mounted to a portion of the boot body;
an air pump in fluid communication with the array of air pockets; and
a micro-processor operative to control the air pump;
wherein the array of air pockets is positioned on a posterior side of the portion of the lower extremity; and
selectively inflating and deflating the air pockets in the array of air pockets, thus relieving pressure on the posterior side of the lower extremity and keeping the blood in the lower extremity moving.

12. The method according to claim 11, wherein the step of inflating and deflating the air pockets in the array of air pockets further applies pressure at regular intervals to increase circulation and relieve pressure in the portion of the lower extremity with which the pressure ulcer boot is in contact.

13. The method according to claim 12, wherein the step of placing the flexible pressure ulcer boot in contact with a portion of the lower extremity includes wrapping the boot body around the portion of the lower extremity to place the flexible pressure ulcer boot in contact with the portion of the lower extremity.

14. The method according to claim 12, wherein the pressure ulcer boot further includes a plurality of straps and buckles, wherein the boot body is configured to wrap around and be placed in contact with the portion of the lower extremity, and wherein the pressure ulcer boot is secured to the lower extremity with the plurality of straps and buckles.

15. The method according to claim 12, wherein the pressure ulcer boot further includes a plurality of air-flow tubes fluidly connecting the air pump to the array of air pockets.

16. The method according to claim 15, wherein the pressure ulcer boot further includes one or more air-flow valves attached within one or more of the plurality of air-flow tubes.

17. The method according to claim 12, wherein the pressure ulcer boot further includes a source of power electrically connected to the micro-processor and to the air pump.

18. The method according to claim 15, wherein the pressure ulcer boot further includes a source of power electrically connected to the micro-processor, the air pump, and to the one or more air-flow valves.

19. The method according to claim 12, wherein the boot body is formed from two layers of material between which the array of air pockets is mounted.

20. A pressure ulcer boot comprising:
a boot body formed from two layers of flexible foam material;
an array of selectively inflatable and deflatable air pockets mounted between the two layers of flexible foam material;
an air pump in fluid communication with the array of air pockets; and
a micro-processor operative to control the air pump to selectively inflate and deflate the air pockets and to apply pressure via the air pockets at regular intervals to increase circulation and relieve pressure in a portion of a patient's body to which the pressure ulcer boot is in contact;
wherein the boot body is configured to wrap around the portion of the patient's body such that the array of air pockets is positioned on a posterior side of the portion of the patient's body; and
wherein the pressure ulcer boot is configured to be secured to the portion of the patient's body with at least one fastening strap.
